(19) United States
(12) Patent Application Publication
(10) Pub. No.: US 2003/0046313 A1
(43) Pub. Date: Mar. 6, 2003

(54) Techniques for restoring data based on contents and attributes of the data

(75) Inventors: Albert Leung, Los Altos, CA (US); Giovanni Paliska, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arkivio, Inc., Mountain View, CA (US)

(21) Appl. No.: 10/229,299

(22) Filed: Aug. 26, 2002

Related U.S. Application Data
(60) Provisional application No. 60/316,783, filed on Aug. 31, 2001.

(51) Int. Cl. G06F 17/30; G06F 12/00

(52) U.S. Cl. 707/204; 707/202

(57) ABSTRACT

Techniques for restoring data in a heterogeneous storage environment. The data to be restored may be identified based upon user-specified contents and/or attributes of the data. The data to be restored may be identified from backup data, archived data, and other types of data. A single search-oriented uniform user interface is provided to restore data irrespective of the storage location of the data. Access to data regardless of the location and type (e.g., archived, backup, or otherwise) of the data is enabled.

### CROSS-REFERENCES TO RELATED APPLICATIONS

The present application claims priority from and is a non-provisional application of U.S. Provisional Patent Application No. 60/316,783, entitled “FILE CONTENT AND ATTRIBUTES INDEXING FOR RETRIEVAL” filed Aug. 31, 2001, the entire contents of which are herein incorporated by reference for all purposes.

### BACKGROUND OF THE INVENTION

The present invention relates to data storage and management, and more particularly to techniques for facilitating retrieval of data based upon contents and attributes of the data.

Several data storage and backup applications are conventionally available that backup data from disk subsystems to backup media such as tapes (or other offline media) as backup sets. The data may be stored in the form of storage units such as files and directories. As part of the backup procedure, the backup applications create a catalog (referred to as a “backup catalog”) that identifies the contents included in each backup set. For example, for each backup set, the backup catalog indicates files and directories included in the backup set. The files and directories in the backup catalog are generally identified using computer-centric file names and directory names. The backup catalog may also possibly identify a media identifier (ID) (e.g., an offline media ID) identifying the backup media used for the backup. One or more backup catalogs may be generated for the stored data.

Backup catalogs generated by a backup application are generally stored on the backup media itself and on local hard drives. When a user needs to restore a particular file from the backup media, the user has to first search the multiple backup catalogs to identify the backup set which includes the particular file. The backup set may indirectly identify the backup media storing the particular file. Presently, searching for the particular file in the backup catalog is based upon full file specifications for the particular file. Accordingly, the user has to know the exact name of the file that the user wishes to restore. If the user forgets the exact file name for a particular file, then the user is forced to browse through the multiple backup catalogs to identify a file name associated with the particular file. Moreover, if the user cannot determine the file name for the particular file from the backup catalogs, then the user may have to restore multiple files from the backup media until the correct user-desired file is retrieved. The problem is further compounded if the user is interested in restoring multiple files.

Accordingly, as described above, conventional data management and data storage applications require the user to know the complete file specification (e.g., the file name for the particular file) for a particular file before the particular file can be restored from backup or archived data. This can be quite cumbersome and inconvenient given the large number of files and directories which may be stored and the cryptic names that are generally associated with the stored files. Accordingly, data restoration, especially restoring backed up data and archived data, can be a time-consuming and cumbersome operation for the user or for a system administrator administering the data storage system. This in turn can increase the information-technology (IT) related costs for an organization or company and detrimentally impact revenues for the organization or company.

In light of the above, techniques that simplify data storage and restoration operations are desirable. Additionally, techniques that provide a simpler and friendlier interface for restoring data are also desirable.

### BRIEF SUMMARY OF THE INVENTION

Embodiments of the present invention provide techniques for restoring data in a heterogeneous storage environment. The data to be restored may be identified based upon user-specified contents and/or attributes of the data. The data to be restored may be identified from backup data, archived data, and other types of data. Embodiments of the present invention thus provide a single search-oriented uniform user interface to restore data irrespective of the storage location of the data. The present invention thus facilitates access to data regardless of the location and type (e.g., archived, backup, or otherwise) of the data.

According to an embodiment of the present invention, techniques are provided for restoring one or more files from a plurality of files stored on a plurality of storage devices in a storage environment, the plurality of files comprising at least one of a backup file and an archived file. In this embodiment, information related to contents of files in the plurality of files and location information identifying storage locations for files in the plurality of files is stored. A request is received comprising information identifying a first content. In response, the embodiment of the present invention determines, based upon the information related to the contents of the plurality of files, a first set of one or more files from the plurality of files that comprise the first content. Storage location information for at least one file in the first set of files is determined based upon the location information. The storage location information comprises information identifying a first storage device from the plurality of storage devices on which the at least one file is stored. The at least one file is restored from the first storage device.

According to another embodiment of the present invention, techniques are provided for restoring one or more files from a plurality of files stored on a plurality of storage devices in a storage environment, the plurality of files comprising at least one of a backup file and an archived file. In this embodiment, attributes information identifying one or more attributes for each file in the plurality of files and location information identifying storage locations for files in the plurality of files is stored. A request is received comprising information identifying a first attribute. In response, the embodiment of the present invention determines, based upon the attributes information, a first set of one or more files from the plurality of files that satisfy the first attribute. Storage location information for at least one file in the first set of files is determined based upon the location information. The storage location information comprises information identifying a first storage device from the plurality of storage devices on which the at least one file is stored. The at least one file is restored from the first storage device.

According to yet another embodiment of the present invention, techniques are provided for restoring one or more files from a plurality of files stored on a plurality of storage devices in a storage environment, the plurality of files comprising at least one of a backup file and an archived file. In this embodiment, information related to contents of files in the plurality of files and attributes information identifying one or more attributes for files in the plurality of files is stored. Location information identifying storage locations for files in the plurality of files is also accessible to the present embodiment. A request comprising information identifying a first criterion is received. The present embodiment determines a first set of one or more files from the plurality of files that satisfy the first criterion based upon the attributes information and the information related to the contents of the files in the plurality of files. The present embodiment determines, based upon the location information, storage location information for at least one file in the first set of files, the storage location information comprising information identifying a first storage device from the plurality of storage devices on which the at least one file is stored. The at least one file is restored from the first storage device.

The foregoing, together with other features, embodiments, and advantages of the present invention, will become more apparent when referring to the following specification, claims, and accompanying drawings.

### BRIEF DESCRIPTION OF THE DRAWINGS

FIG. 1 is a simplified block diagram of a distributed system that may incorporate an embodiment of the present invention;

FIG. 2 is a simplified block diagram of a computer system according to an embodiment of the present invention;

FIG. 3 is a simplified high-level flowchart of a method of restoring one or more files based upon the contents and/or attributes of the files according to an embodiment of the present invention;

FIG. 4 is a simplified high-level flowchart of a method of gathering information related to a file that is used to facilitate restoration of the file according to an embodiment of the present invention;

FIG. 5A depicts a portion of file-related information comprising information related to contents of files that may be stored according to an embodiment of the present invention;

FIG. 5B depicts a portion of file-related information comprising information related to attributes of files that may be stored according to an embodiment of the present invention;

FIG. 6 depicts a portion of location information for files that may be stored in a location database according to an embodiment of the present invention;

FIG. 7 is a simplified high-level flowchart of a method of indexing content and/or attributes information for a file according to an embodiment of the present invention; and

FIG. 8 is a simplified high-level flowchart depicting a method of restoring a file according to an embodiment of the present invention.

### DETAILED DESCRIPTION OF THE INVENTION

Embodiments of the present invention provide techniques for restoring data in a heterogeneous storage environment. The data to be restored may be identified based upon user-specified contents and/or attributes of the data. The data to be restored may be identified from backup data, archived data, and other types of data. Embodiments of the present invention thus provide a single search-oriented uniform user interface to restore data irrespective of the storage location of the data. The present invention thus facilitates access to data regardless of the location and type (e.g., archived, backup, or otherwise) of the data.

According to an embodiment of the present invention, techniques are provided that offer simpler and friendlier interfaces for restoring data that may be stored, backed-up, or archived in a heterogeneous storage environment. The restoration of the data is transparent to the user irrespective of the storage location of the data and the type of data (e.g., back-up data, archived data, etc.).

For purposes of this application, the term “backup data” (or “backup file” if the data is stored in file format) is intended to refer to data that is stored on a nonvolatile storage medium for purposes of recovery in case the original copy of data is lost or becomes inaccessible. The backup data of backup copy is usually stored on a removable storage media such as a tape. Conventionally, explicit actions are required to identify contents of backup data to be restored and to restore the backup data from the backup medium. As a result, conventionally, identification of backup data to be restored and restoration of the identified backup data is not transparent to the user. For example, contents of backup files cannot conveniently be searched to identify one or more backup files that include specific content or files that have specific attributes associated with them. As described in the “Background of the invention” section, conventionally, in order to restore a particular backup file, a user has to search multiple backup catalogs using full filename specification to identify a backup set which includes the particular file, restore all the files in backup set, then search the restored files to locate the particular file comprising the desired content.

For purposes of this application, the term “archived data” (or “archived files” if the data is stored in file format) is intended to refer to a copy of a collection of data taken for the purpose of maintaining a long-term durable record of the collection of data. The original collection of data may be deleted when the data has been archived. Archived data is generally stored on a removable media such as a tape and may include one or more data files. Conventionally, explicit actions are required to identify contents of archived data to be restored and to restore the archived data from the archival medium. As a result, conventionally, identification of archived data to be restored and restoration of the identified archived data is not transparent to the user. For example, contents of archived files cannot conveniently be searched to identify one or more archived files that include specific content or files that have specific attributes associated with them. Accordingly, using conventional techniques, in order to restore a particular archived file, a user has to search multiple archive catalogs using full filename specification to identify an archived set that includes the particular file, restore all the files in the archived set, and then search the restored files to locate the particular file comprising the desired content.

For purposes of this application, the term “restoring data” is intended to refer to retrieving or accessing data from its storage location and making it available to a data requestor or user. For example, a data file is considered restored when a user can access the data stored by the data file. According to an embodiment of the present invention, restoration of the data is transparent to the user irrespective of the storage location or type (e.g., original data, backup data, archived data, etc.) of the data. Embodiments of the present invention are capable of identifying data to be restored from original data, backup data, archived data, and other types of data. A user does not have to take explicit actions to identify the data to be restored.

Embodiments of the present invention are capable of identifying one or more data files to be restored that satisfy user-specified criteria. The user-specified criteria may include user-specified content and/or one or more file attributes. The one or more files to be restored may be identified from a plurality of files including backup files and archived files. For example, one or more files that comprise user-specified content and/or user-specified attributes may be identified for restoration. One or more of the identified file may then be restored. The user does not have to remember the full file specifications (e.g., full filenames) to identify and restore the files. As a result, the need to search multiple backup catalogs or archive catalogs is obviated.

According to the teachings of the present invention, the user can retrieve a file by knowing information about the contents or attributes of the file to be restored. The contents or attributes that may be used to restore a file may include one or more words in the file, a topic or subject to which the file contents relate, authorship information for the file, time information associated with the file (e.g., time when the file was created, time when the file was last modified, etc.), and other like file-related information.

The embodiment of the present invention described below describes techniques for restoring data files from a plurality of data files including backup files and archived files. It should however be understood that the teachings of the present invention may also be used to restore data from other types of storage units known to those skilled in the art. For example, teachings of the present invention may also be applied for restoring block data. Accordingly, the embodiments of the present invention described below are not meant to limit the scope of the present invention.

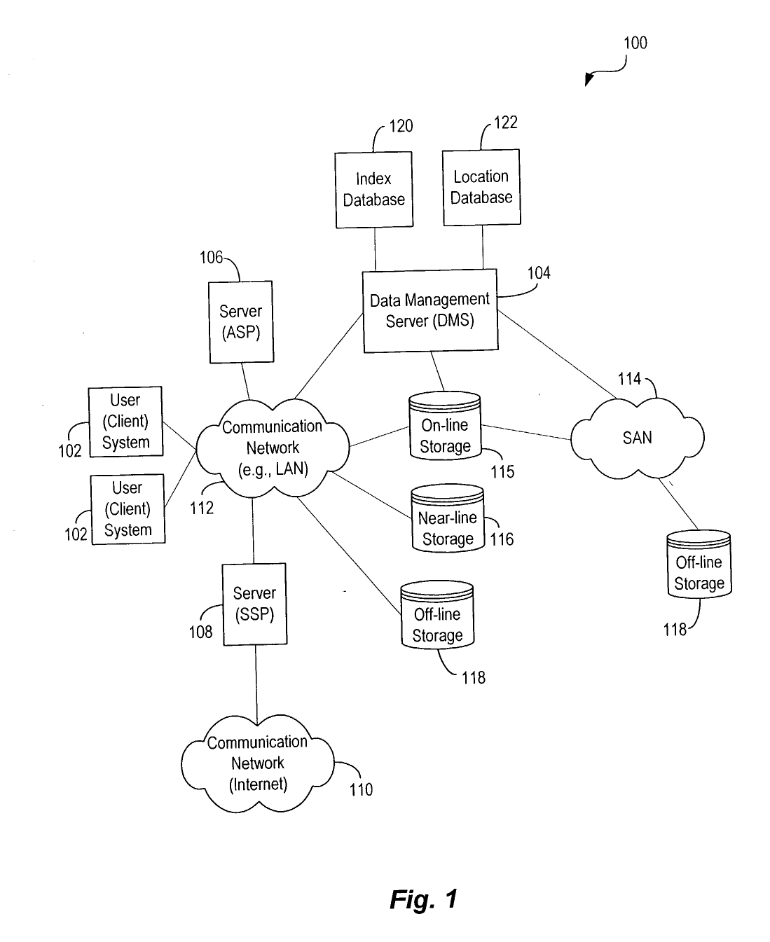

FIG. 1 is a simplified block diagram of a distributed system 100 that may incorporate an embodiment of the present invention. Distributed system 100 comprises a plurality of computer systems and storage devices coupled to one or more communication networks via a plurality of communication links. As depicted in FIG. 1, the plurality of computer systems comprise one or more user (client) systems 102 coupled to communication network 112, a plurality of server systems including a data management server (DMS) 104 coupled to communication network 112 and storage area network (SAN) 114, an application service provider (ASP) server 106 coupled to communication network 112, and a server 108 providing connectivity to a communication network 110 such as the Internet. Distributed computer network 100 depicted in FIG. 1 is merely illustrative of an embodiment incorporating the present invention and does not limit the scope of the invention as recited in the claims. One of ordinary skill in the art would recognize other variations, modifications, and alternatives.

The communication networks depicted in FIG. 1 such as communication networks 112 and 110 provide a mechanism for allowing communication and exchange of information between the various computer systems and storage devices depicted in FIG. 1. The communication networks may themselves be comprised of many interconnected computer systems and communication links. For example, communication network 112 may be a LAN (as depicted in FIG. 1), a wide area network (WAN), a wireless network, an Intranet, a private network, a public network, a switched network, or any other suitable communication network. Likewise, communication network 110 may also be any other communication network such as an Internet (as depicted in FIG. 1), or any other computer network.

The communication links used to connect the various systems depicted in FIG. 1 may be of various types including hardwire links, optical links, satellite or other wireless communications links, wave propagation links, or any other mechanisms for communication of information. Various communication protocols may be used to facilitate communication of information via the communication links. These communication protocols may include TCP/IP, HTTP protocols, extensible markup language (XML), wireless application protocol (WAP), Fiber Channel protocols, protocols under development by industry standard organizations, vendor-specific protocols, customized protocols, and others.

Computer systems connected to a distributed computer network such as network 100 depicted in FIG. 1 can generally be classified as “clients” or “servers” depending on the roles the computer systems play with respect to requesting information or a service or storing/providing information or a service. Computers systems that are used by users to configure information requests or service requests are typically referred to as “client” computers. Computer systems that receive information requests and/or service requests from client systems, perform processing required to satisfy the requests, and forward the results/information corresponding to the requests back to the requesting client systems are usually referred to as “server” systems. The processing required to satisfy a client request may be performed by a single server system or may alternatively be delegated to other servers. Accordingly, the server systems depicted in FIG. 1 are configured to provide information and/or provide a service requested by requests received from one or more client computers. It should however be understood that a particular computer system might function both as a server and a client.

Users of the present invention may use client systems 102 to access data stored by one or more files stored by the storage devices depicted in FIG. 1. According to an embodiment of the present invention, a user may use client system 102 to configure a request to identify and restore one or more files stored by distributed system 100. In order to identify files to be restored, a user may, as part of the request, specify information related to the contents and/or attributes of the files to be restored. Users may also use client systems 102 to interact with the other systems depicted in FIG. 1. For example, a user may use client system 102 to interact with data management server (DMS) 104. Client system 102 may be of different types including a personal computer, a portable computer, a workstation, a computer terminal, a network computer, a mainframe, a kiosk, a personal digital assistant (PDA), a communication device such as a cell phone, or any other data processing system.

DMS 104 is configured to receive file restoration requests and to perform processing to facilitate identification and restoration of one or more files based upon contents and/or attributes information specified in the file restoration requests. Information used by DMS 104 to facilitate identification of one or more files to be restored based upon information included in a file restoration request and to restore the identified files may be stored in a memory location accessible to DMS 104. For example, the information may be stored in one or more databases accessible to DMS 104. In the embodiment depicted in FIG. 1, the information is stored in an index database 120 and a location database 122 accessible to DMS 104. Further details related to processing performed by DMS 104 are described below.

According to the teachings of the present invention, the processing performed by DMS 104 to identify and restore one or more files may be implemented by software modules executed by DMS 104, by hardware modules coupled to DMS 104, or combinations thereof. In alternative embodiments of the present invention, the processing may also be performed by other computer systems and devices coupled to DMS 104.

According to an embodiment of the present invention, distributed system 100 comprises one or more storage devices that are used to store data files including backup data files and archived data files. Various different types of devices may be used to store the files. The files may be stored by dedicated storage devices (e.g., devices 1115, 116, and 118), by various computer systems (e.g., client and server systems), removable storage devices, and others. Examples of storage devices include tapes, disk drives, optical disks, solid state storage, and other types of computer-readable storage media. In general, use of the term “storage device” is intended to refer to any system, subsystem, device, computer medium, network, or other like system or mechanism that is capable of storing data in digital or electronic form. The storage devices may be directly coupled to DMS, coupled to DMS 104 via a communication network such as communication network 112, coupled to DMS 104 via storage networks (e.g., storage area network (SAN) 114, network attached storage (NAS), etc.), and via other techniques. Some of the data files, for example, archived and backup data files, that are stored on the storage devices may not be directly browsed or searched.

As is known to those skilled in the art, storage devices are generally characterized by the amount of time required to access data (referred to as “data access time”) stored by the storage devices. Accordingly, storage devices that are used to store data files may be characterized as on-line storage devices 115, near-line storage devices 116, off-line storage devices 118, and others. The data access time for an on-line storage device is generally shorter than the access time for a near-line storage device. The access time for an off-line storage is generally longer than the access time for a near-line storage device. An off-line storage device is generally a device that is not readily accessible to DMS 104. Offline storage devices are generally used to store archived data and backup data. Examples of off-line storage devices include computer-readable storage media such as disk drives, tapes, optical devices, and the like. An off-line storage device has to be made accessible before data stored by the storage device can be restored. For example, if a removable tape is used as an off-line device, the user may have to make the tape accessible to DMS 104 before data stored on the tape can be restored by DMS 104.

It should be understood that various other criteria might also be used to classify or characterize storage devices. Classification of a storage device is not required by the present invention and should not be construed to limit the scope of the present invention as recited in the claims.

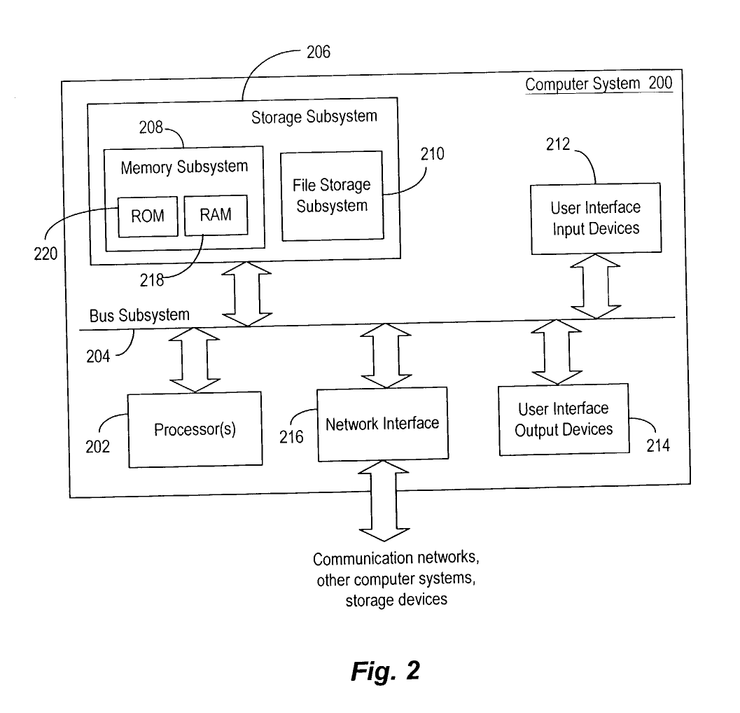

FIG. 2 is a simplified block diagram of a computer system 200 depicted in FIG. 1 according to an embodiment of the present invention. As indicated above, computer system 200 may be embodied as a client system or a server system (e.g., DMS 104) depicted in FIG. 1. As shown in FIG. 2, computer system 200 includes at least one processor 202, which communicates with a number of peripheral devices via a bus subsystem 204. These peripheral devices may include a storage subsystem 206, comprising a memory subsystem 208 and a file storage subsystem 210, user interface input devices 212, user interface output devices 214, and a network interface subsystem 216. The input and output devices allow user interaction with computer system 200. A user may be a human user, a device, a process, another computer, and the like. Network interface subsystem 216 provides an interface to other computer systems, storage devices, and communication networks.

Bus subsystem 204 provides a mechanism for letting the various components and subsystems of computer system 200 communicate with each other as intended. The various subsystems and components of computer system 200 need not be at the same physical location but may be distributed at various locations within network 100. Although bus subsystem 204 is shown schematically as a single bus, alternative embodiments of the bus subsystem may utilize multiple busses.

User interface input devices 212 may include a keyboard, pointing devices, a mouse, trackball, touchpad, a graphics tablet, a scanner, a barcode scanner, a touchscreen incorporated into the display, audio input devices such as voice recognition systems, microphones, and other types of input devices. In general, use of the term “input device” is intended to include all possible types of devices and ways to input information using computer system 200.

User interface output devices 214 may include a display subsystem, a printer, a fax machine, or non-visual displays such as audio output devices. The display subsystem may be a cathode ray tube (CRT), a flat-panel device such as a liquid crystal display (LCD), or a projection device. In general, use of the term “output device” is intended to include all possible types of devices and ways to output information from computer system 200.

Storage subsystem 206 may be configured to store the basic programming and data constructs that provide the functionality of the computer system and of the present invention. For example, according to an embodiment of the present invention, software modules implementing the functionality of the present invention may be stored in storage subsystem 206 of DMS 104. These software modules may be executed by processor(s) 202 of DMS 104. Storage subsystem 206 may also provide a repository for storing information that may be used by the present invention. Storage subsystem 206 may comprise memory subsystem 208 and file storage subsystem 210.

Memory subsystem 208 may include a number of memories including a main random access memory (RAM) 218 for storage of instructions and data during program execution and a read only memory (ROM) 220 in which fixed instructions are stored. File storage subsystem 210 provides persistent (non-volatile) storage for program and data files, and may include a hard disk drive, a floppy disk drive along with associated removable media, a Compact Digital Read Only Memory (CD-ROM) drive, an optical drive, removable media cartridges, and other like storage media. One or more of the drives may be located at remote locations on other connected computers.

Computer system 200 itself can be of varying types including a personal computer, a portable computer, a workstation, a network computer, a mainframe, a kiosk, a personal digital assistant (PDA), a communication device such as a cell phone, or any other data processing system. Due to the ever-changing nature of computers and networks, the description of computer system 200 depicted in FIG. 2 is intended only as a specific example for purposes of illustrating the preferred embodiment of the computer system. Many other configurations of a computer system are possible having more or fewer components than the computer system depicted in FIG. 2.

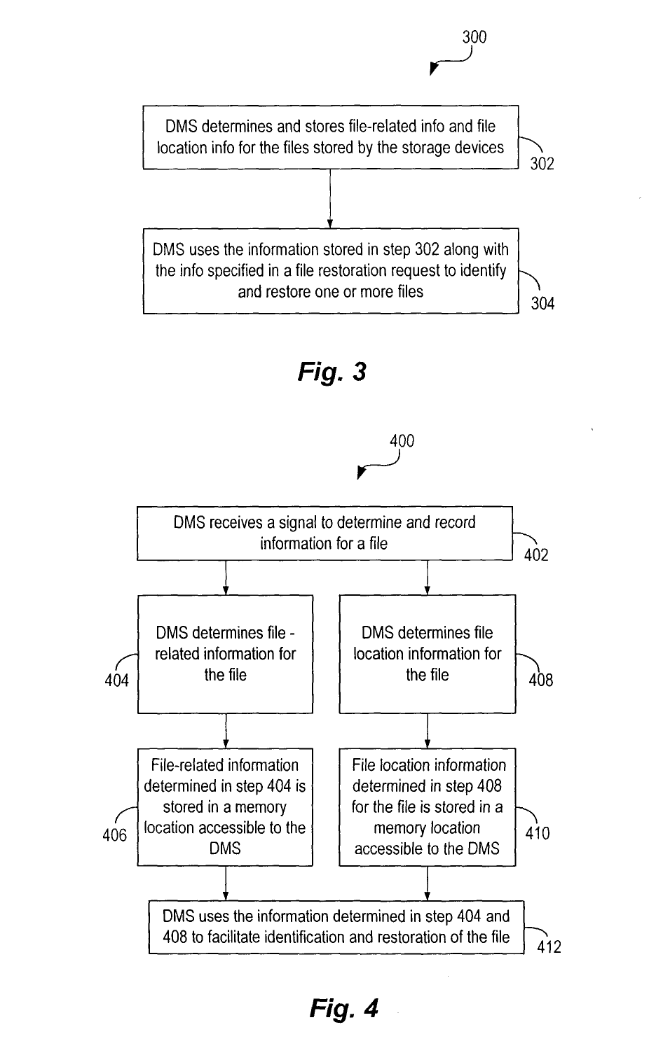

FIG. 3 is a simplified high-level flowchart 300 of a method of identifying and restoring one or more data files based upon contents and/or attributes of the files according to an embodiment of the present invention. The processing depicted in FIG. 3 may be performed by software modules executed by DMS 104, by hardware modules coupled to DMS 104, or combinations thereof. Flowchart 300 depicted in FIG. 3 is merely illustrative of an embodiment incorporating the present invention and does not limit the scope of the invention as recited in the claims. One of ordinary skill in the art would recognize other variations, modifications, and alternatives.

As depicted in FIG. 3, in order to facilitate restoration of data files, DMS 104 gathers and stores information related to the contents and/or attributes of the various data files, including archived and backup files, stored by one or more storage devices in distributed system 100 (step 302). The information (also referred to as “file-related information”) stored by DMS 104 for a data file may include information related to the contents of the data file and/or information identifying one or more attributes of the data file. DMS 104 may determine and store the file-related information for the data files on a continuous or periodic basis or upon the occurrence of a particular event. For example, according to an embodiment of the present invention, DMS 104 tracks and records file-related information each time a file is created, modified, closed, saved, deleted, archived, backed-up, and the like. According to an embodiment of the present invention, as part of step 302, DMS 104 creates and stores an index (or mapping) of the stored data files and file-related information for each stored data file. In the embodiment depicted in FIG. 1, the indexing information is stored in index database 120.

As part of step 302, DMS 104 also tracks and records information identifying the storage devices used to store the data files and the locations on the storage locations where the files are stored. Accordingly, DMS 104 stores “file location information” for each data file that includes information identifying the storage device on which the file is stored and information identifying the location on the storage device where the file is stored. In the embodiment depicted in FIG. 1, the file location information is stored in location database 122. It should be understood that various different formats may be used to store the physical locations information. According to an embodiment of the present invention, DMS 104 tracks and records the file location information for a file each time a file is created, modified, closed, saved, deleted, archived, backed-up, and the like.

It should be understood that various different formats may be used to store the indexing information and the file location information. For example, according to an embodiment of the present invention, the index information and the location information are combined and stored in a single database. In other embodiments, the information may be stored in multiple databases.

The information determined and stored in step 302 is then used to identify and restore one or more data files that match the contents and/or attributes criteria specified in file restoration requests (step 304). Further details related to the processing performed in step 304 are provided below.

It should be understood that in alternative embodiments of the present invention, the processing performed in step 302 of FIG. 3 may be performed by a computer system other than DMS 104. In this embodiment, the information determined in step 302 might be stored in a memory location accessible to DMS 104. DMS 104 may then use the stored information to perform the processing depicted in step 304 of FIG. 3.

FIG. 4 is a simplified high-level flowchart 400 of a method of gathering information related to a file that is used to facilitate restoration of the file according to an embodiment of the present invention. According to an embodiment of the present invention, the processing depicted in FIG. 4 is performed by software modules executing on DMS 104, by hardware module coupled to DMS 104, or a combination thereof. The processing depicted in FIG. 4 is performed for each stored data file. Flowchart 400 depicted in FIG. 4 is merely illustrative of an embodiment incorporating the present invention and does not limit the scope of the invention as recited in the claims. One of ordinary skill in the art would recognize other variations, modifications, and alternatives.

As depicted in the FIG. 4, the method is initiated when DMS 104 receives a signal to determine and record information for a particular file (step 402). According to an embodiment of the present invention, the information to be determined and recorded for a file includes file-related information comprising information related to contents of the particular file and attributes of the file, and file location information comprising information identifying the storage device on which the file is stored and information identifying the location on the storage device where the file is stored.

According to an embodiment of the present invention, DMS 104 may receive the signal upon the occurrence of an event. For example, DMS 104 may receive the signal when a file is created, modified, closed, saved, deleted, archived, backed-up, or the like. Alternatively, the signal may be received at periodic time intervals. The signal may be received from a plurality of different sources including processes or applications (e.g., a timer application) executing on DMS 104, or from other applications or devices.

In response to the signal received in step 402, DMS 104 determines information related to the contents and/or attributes of the particular file (step 404). Information related to the contents of the file may comprise one or more words, phrases, images, etc. included in the particular file. Information related to the attributes of the file may include information identifying one or more attributes of the particular file. For example, the attribute information may include information related to authorship of the particular file, the time of creation of the file, time the file was last modified, time the file was last accessed, department name or domain to which the file belongs, custom properties that may be associated with a file, and other information associated with the file. According to an embodiment of the present invention, DMS 104 may determine content and attributes information for various versions of the particular file.

The information related to the contents and attributes of the file determined in step 404 is then stored in a memory location accessible to DMS 104 (step 406). According to an embodiment of the present invention, DMS 104 generates an index (or mapping) based on the content and attribute information determined for the particular file. The index information may be stored in index database 120 accessible to DMS 104.

In response to the signal received in step 402, DMS also determines file location information indicating the physical location of the particular file (step 408). As indicated above, the file location information comprises information identifying a storage device on which the file is stored and the location (e.g., a directory path, pathname, etc.) on the storage device where the file is stored. For example, if the file is stored on an off-line storage device, the file location information for the file may identify a media identifier identifying the computer-readable off-line storage device or medium and the location on the off-line storage device where the file is stored. If the file is stored on an on-line or near-line storage device, the physical location information for the file may identify a storage subsystem or system where the file is stored. According to an embodiment of the present invention, the file location information also comprises information indicating whether the file has been migrated from a local storage system of a client computer to another storage device.

The file location information determined in step 408 for the particular file is then stored in a memory location accessible to DMS 104 (step 410). According to an embodiment of the present invention, the file location information is stored in location database 122 that is accessible to DMS 104.

DMS 104 then uses the file-related information (including information related to contents and/or attributes of the file) and the file location information to facilitate identification and restoration of the file in response to file restoration requests according to an embodiment of the present invention (step 412). For example, according to an embodiment of the present invention, DMS 104 uses information stored in index database 120 and location database 122 to facilitate restoration of one or more files.

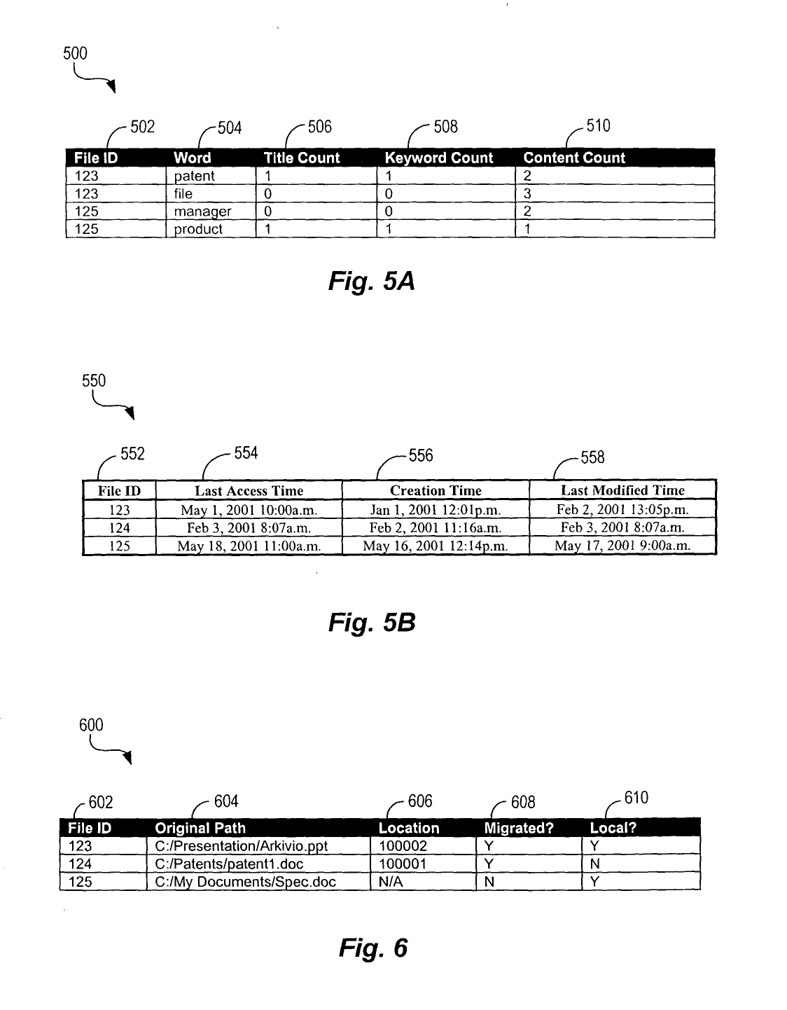

FIG. 5A depicts a portion of file-related information comprising information related to contents of files that may be stored in index database 120 according to an embodiment of the present invention. In the embodiment depicted in FIG. 5A, the information is stored in the form of a table 500. However, various other formats may be used to store the information in alternative embodiments of the present invention.

Table 500 depicted in FIG. 5A comprises a plurality of rows wherein each row stores information related to a particular content for a particular file. As depicted in FIG. 5A, column 502 of table 500 stores information identifying a file that contains the content information identified by column 504. Various different techniques may be used to identify a file in column 502. In the embodiment depicted in FIG. 5A each file is identified by a file identifier (e.g., identifier “123”) assigned to the file.

The content information stored by column 504 may identify a word, phrase, image, etc. contained in the file identified by column 502. In the embodiment depicted in FIG. 5A, column 504 identifies a word stored by the file identified in column 502 (e.g., the first line of table 500 indicates that word “patent” is contained in the file identified by file identifier “123”). Other types of content information and textual attributes may also stored in column 504 in alternative embodiments of the present invention.

Column 506 identifies a title count for the word identified by column 504. The title count for a word indicates the number of occurrences (or frequency) of the word identified by column 504 in the title information associated with the file identified by column 502. The title information may refer to the filename associated with the file identified in column 502 or a title attribute associated with the file identified in column 502.

Column 508 identifies a keyword count for a word identified by column 504. The keyword count indicates the frequency of the word identified by column 504 in a keyword attribute associated with the file identified in column 502. Column 510 identifies a content count for the word identified in column 504. The content count indicates the number of times that the word identified in column 504 occurs in the contents of the file identified in column 502. For example, the first line of table 500 depicted in FIG. 5A indicates that the word “patent” occurs once in the title information associated with file “123”, occurs once in the keyword attribute associated with file “123”, and occurs twice in the contents of file “123.”

Table 500 depicted in FIG. 5A is merely illustrative of an embodiment of file-related information that is stored in index database 120 and does not limit the scope of the invention. One of ordinary skill in the art would recognize other variations, modifications, and alternatives.

As described above, according to an embodiment of the present invention, the file-related information stored in index database 120 is automatically updated by DMS 104 whenever a file is created, modified, closed, saved, deleted, archived, backed-up, etc. When a new file is created, one or more new records corresponding to the newly created file is added to index database 120. When an existing file is modified, the information in index database 120 is updated to correspond to the modified file. According to an embodiment of the present invention, information related to a file may be deleted (or marked as invalid) from index database 120 when the file is deleted.

FIG. 5B depicts a portion of file-related information comprising information related to attributes of files that may be stored in index database 120 according to an embodiment of the present invention. In the embodiment depicted in FIG. 5B, the information is stored in the form of a table 550. However, various other formats may be used to store the information in alternative embodiments of the present invention.

Table 550 depicted in FIG. 5B comprises a plurality of rows wherein each row stores information related to attributes for a particular file. As depicted in FIG. 5B, column 552 of table 550 stores information identifying a file. Various different techniques may be used to identify a file in column 552. In the embodiment depicted in FIG. 5B each file is identified by a file identifier (e.g., identifier “123”) assigned to the file.

Columns 554, 556, and 558 store information related to various attributes of the file identified in column 552. For example, in table 550 depicted in FIG. 5B, column 554 stores information indicating the last access time of the file identified in column 552, column 556 stores information indicating the creation time of the file identified in column 552, and column 558 stores information indicating the last modification time of the file identified in column 552.

It should be understood table 550 depicted in FIG. 5B is merely illustrative of an embodiment of file-related information that is stored in index database 120 and does not limit the scope of the invention. One of ordinary skill in the art would recognize other variations, modifications, and alternatives. For example, table 550 may comprise more or less columns than the number of columns depicted in FIG. 5B storing more or less attributes of the files.

As described above, according to an embodiment of the present invention, the attribute information stored in index database 120 is automatically updated by DMS 104 whenever a file is created, modified, closed, saved, deleted, archived, backed-up, etc. When a new file is created, a new record corresponding to the newly created file is added to index database 120. When an existing file is modified, the information in index database 120 is updated to correspond to the modified file. According to an embodiment of the present invention, information related to a file may be deleted (or marked as invalid) from index database 120 when the file is deleted.

FIG. 6 depicts a portion of file location information for files according to an embodiment of the present invention. The information may be stored in location database 122. In the embodiment depicted in FIG. 6, the information is stored in the form of a table 600. However, various other formats may be used for storing the location information in alternative embodiments of the present invention.

Table 600 depicted in FIG. 6 comprises a plurality of rows wherein each row stores file location information for a file. Column 602 stores information identifying the one or more files for which location information is stored. Various different techniques may be used to identify the files. In the embodiment depicted in FIG. 6, each file is identified using a file identifier (e.g., identifiers “123”, “124”, “125”, etc.) associated with the file.

For a particular file identified by column 602, column 604 stores information identifying a directory pathname under which the file is stored on a storage device identified by column 606. Column 606 stores information identifying a storage device on which the file identified in column 602 is stored. As depicted in FIG. 6, a storage device identifier (or media ID) may be used to identify the storage device on which the file is stored. The storage device may be an on-line storage device, a near-line storage device, or an off-line storage device.

Column 608 stores information indicating whether the file identified by column 602 has been migrated from the local system (where the file was created) to backup storage. A “Y” indicates that the file has been migrated to a backup storage device from the client system used to create the file. A “N” indicates that the file has not been migrated from the local system. Column 610 stores information indicating whether the file identified by column 602 is resident on the local system where the file was originally created. A “Y” indicates that the file is stored on the local system, while a “N” indicates that the file is no longer stored on the local system.

It should be understood that table 600 depicted in FIG. 6 is merely illustrative of an embodiment of file location information and does not limit the scope of the invention. One of ordinary skill in the art would recognize other variations, modifications, and alternatives.

As described above, the information stored in location database 122 is continuously updated by DMS 104 whenever information related to a file changes (e.g., when the file is created, modified, saved, closed, archived, backed-up, etc.). According to an embodiment of the present invention, the information stored in location database 122 is updated every time that a file is accessed or its location is changed from one storage device to another, or when the directory storing the file changes. For example, for a particular file, information for the file stored in location database 122 is updated every time the particular file is moved from a first storage device to a second storage device which may or may not be of the same type as the first storage device. For example, when the file is moved from the local system to on-line storage, from on-line storage to near-line storage, from near-line storage to off-line storage, from off-line storage to near-line storage, from near-line storage to on-line storage, and the like).

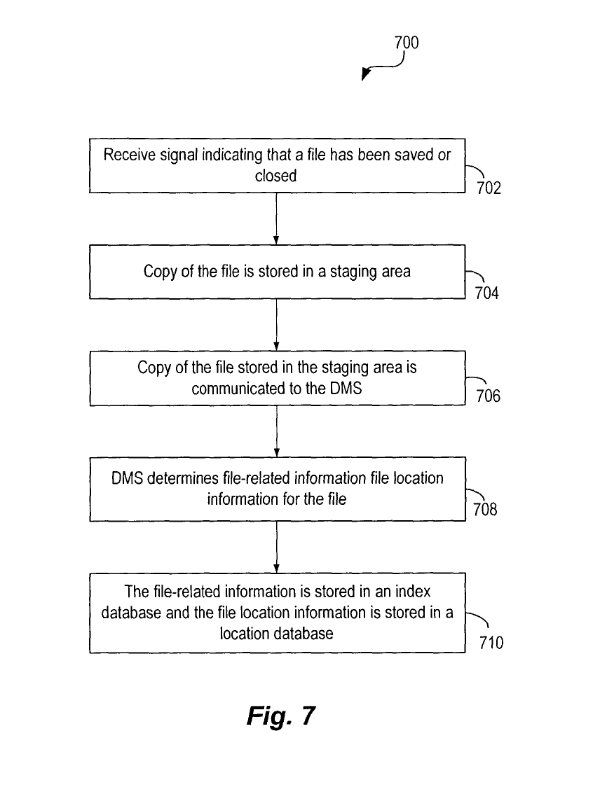

FIG. 7 is a simplified high-level flowchart 700 of a method of indexing content and/or attributes information for a file according to an embodiment of the present invention. Flowchart 700 depicted in FIG. 7 is merely illustrative of an embodiment incorporating the present invention and does not limit the scope of the invention as recited in the claims. One of ordinary skill in the art would recognize other variations, modifications, and alternatives.

As depicted in FIG. 7, the method is initiated when a signal is received indicating that a file has been saved or closed (step 702). According to an embodiment of the present invention, a process configured to monitor operations performed on the file may receive the signal. For example, a process executing on a particular client system 102 may detect or receive a signal when a file is saved or closed on the particular client system.

In response to the signal received in step 702, a copy of the file is stored in a staging area (step 704). According to an embodiment of the present invention, the staging area is local to the computer system used to create, save, or close the file. The process that detects the signal in step 702 may facilitate copying of the file to the staging area. According to an embodiment of the present invention, the staging area is a “write-only” storage location that may reside on the local computer system. The file may be restored from the staging area. For example, if a user accidentally deletes the file, the user can retrieve the file from the staging area.

The copy of the file stored in the staging area is then communicated to DMS 104 (step 706). DMS 104 then determines file-related information for the file and file location information for the file (step 708). The file-related information is stored in index database 120 and the file location information is stored in location database 122 (step 710). In alternative embodiments of the present invention, the processing performed in steps 706 and 708 may be performed by the user or client system itself instead of DMS 104.

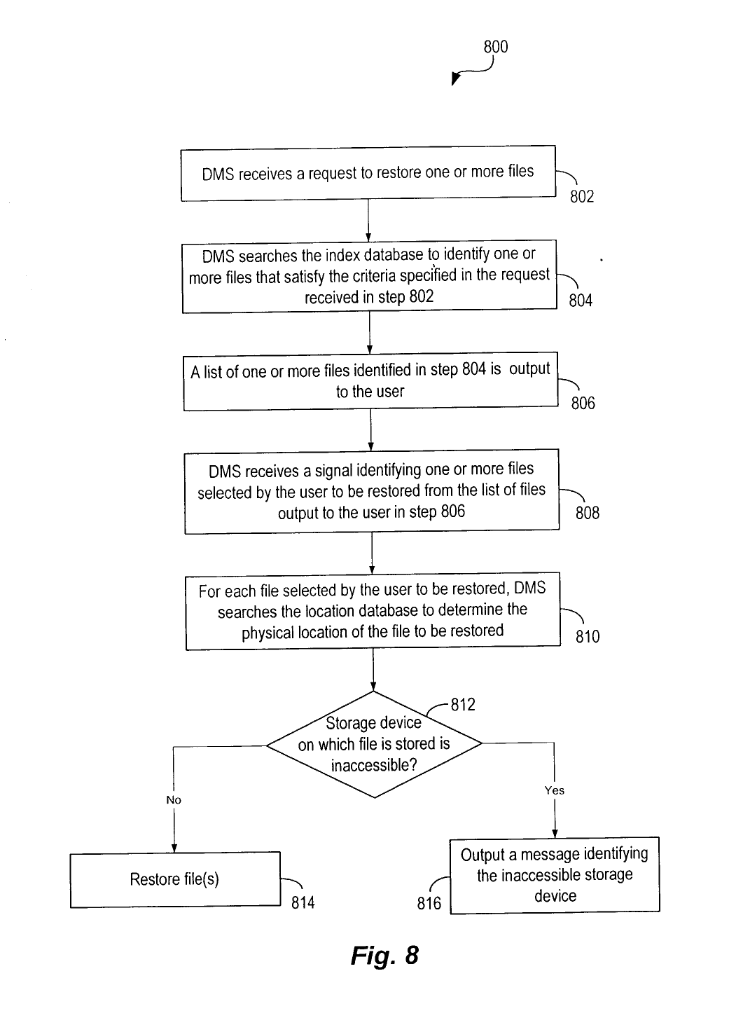

FIG. 8 is a simplified high-level flowchart 800 depicting a method of identifying and restoring a file according to an embodiment of the present invention. Flowchart 800 depicted in FIG. 8 is merely illustrative of an embodiment incorporating the present invention and does not limit the scope of the invention as recited in the claims. The processing depicted in FIG. 8 may be performed by software modules executing on DMS 104, by hardware modules coupled to DMS 104, or combinations thereof. One of ordinary skill in the art would recognize other variations, modifications, and alternatives.

As depicted in FIG. 8, the method is initiated when DMS 104 receives a request to restore one or more files (step 802). According to the teachings of the present invention, the request may comprise information specifying criteria to be used for identifying one or more files to be restored. The criteria may specify contents and/or attributes of the one or more files to be restored. For example, the restoration request criteria may specify one or more words or phrases that a file to be restored must contain. The attribute information specified in the request criteria may identify an author of the file, a time of creation of the file, a time of modification of the file, and other file-related attributes of the file(s) to be restored. Unlike conventional systems, the user does not have to identify the full file specifications (e.g., the full exact file name) in order to restore files.

The request may be received from a plurality of sources. For example, the request may be received from one or more client systems 102, from processes and applications executing on DMS 104 or on other computer systems, from devices and systems coupled to DMS 104, and from other sources.

DMS 104 then searches index database 120 to identify one or more files that satisfy the criteria specified in the request received in step 802 (step 804). The one or more files identified in step 804 may include archived files and/or backup files. The user does not have to take any explicit actions to identify files that are included in archived or backup data.

For example, if the request specified information identifying one or more words, the DMS searches the index database to identify one or more files that contain the one or more specified words. Likewise, if the request received in step 802 specifies information identifying one or more file attributes, DMS 104 searches the index database to identify one or more files that have the same user-specified attribute(s).

According to an embodiment of the present invention, DMS 104 may also rank the one or more files determined in step 804 based upon their relevance to the criteria specified in the restoration request. For example, the files may be ranked based upon the frequency of the specified words in the contents of the file. Various techniques known to those skilled in the art may be used to rank the files based upon their degree of relevance to the request.

A list of one or more files identified in step 804 may then be output to the user (step 806). In embodiments where the files are ranked based upon their degree of relevance to the request, a ranked list of one or more files identified in step 804 may be output to the user in step 806.

The user may then select one or more files to be restored from the list of files output to the user. DMS 104 receives a signal identifying one or more file(s) selected by the user to be restored from the list of files output to the user in step 806 (step 808). For each file selected by the user to be restored, DMS 104 then searches location database 122 to determine the physical location of the file to be restored (step 810).

For each file to be restored, based upon the information for the file determined in step 810, DMS determines if the file is stored on a device (e.g., an off-line device) that in inaccessible to DMS 104 (step 812). If a file is stored on a device that is accessible to DMS 104, the file is automatically restored for the user from the device (step 814). If a file is stored on a storage device that is not accessible to DMS 104, a message is output to the user identifying the inaccessible storage device (step 816). For example, DMS 104 may output a message indicating a media identifier for an off-line storage device storing the file to be restored.

The user may then use the information output in step 816 to restore the file from the inaccessible device. For example, the user may make the storage device identified in step 816 accessible to DMS 104. DMS 104 may then restore the file from the storage device.

In one embodiment of the present invention, steps 806 and 808 may be optional and omitted. In this embodiment, after identifying (in step 804) one or more files that satisfy the information criteria specified in the restoration request, DMS 104 may directly proceed with step 810 wherein DMS 104 determines the physical locations of the one or more files to be restored. In this embodiment the one or more files are restored automatically without requiring any user interaction based on information included in the restoration request received in step 802.

As described above, the present invention provides techniques for identifying and restoring files based upon contents and/or attributes of the files. The files identified for restoration may include archived files and/or backup files. According to the teachings of the present invention, the user does not have to peruse archive or backup catalogs and provide full filenames in order for files to be restored from archived or backup data. The present invention thus provides a simple and easy-to-use interface for specifying criteria to be used to identifying files to be restored, searching a plurality of files including archived and backup files to identify files that satisfy the criteria, and restoring the identified files. The present invention enables an intuitive search, classification, and retrieval capabilities without requiring extensive technical expertise in a heterogeneous storage environment.

According to an embodiment of the present invention, information related to the physical locations of the files, including archived and backup files, is consolidated in a single location database 122. Location database 122 thus provides a single database that stores file locations information across multiple and heterogeneous storage devices. Likewise, information to the content and attributes of the files, including archived and backup files, is consolidated in a single index database 120. By utilizing information stored in location database 122 and index database 120, the present invention provides a single logical data store for retrieving files, including archived and backup files, even though the actual storage locations of the files may be in different devices and systems. This eliminates the need to search or browse backup catalogs in order to restore files from on-line, near-line, or off-line storage devices. The present invention thus provides a single search-oriented uniform user interface to restore data irrespective of the storage location of the data. The present invention thus facilitates access to data regardless of the location and type (e.g., archived, backup, or otherwise) of the data. According to an embodiment of the present invention, the identification of data to be restored and the storage location of the data is transparent to the user. The present invention also allows system administrators and system software applications to determine the location of storage dynamically without user involvement.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. In a storage environment comprising a plurality of storage devices storing a plurality of files, the plurality of files comprising at least one of a backup file and an archived file, a method of restoring one or more files from the plurality of files, the method comprising:
storing information related to contents of files in the plurality of files;
storing location information identifying storage locations for files in the plurality of files;
receiving a request comprising information identifying a first content;
determining, based upon the information related to the contents of the plurality of files, a first set of one or more files from the plurality of files that comprise the first content;
determining, based upon the location information, storage location information for at least one file in the first set of files, the storage location information comprising information identifying a first storage device from the plurality of storage devices on which the at least one file is stored; and
restoring the at least one file from the first storage device.

2. The method of claim 1 further comprising:
outputting information identifying files in the. first set of files; and
receiving a signal indicating selection of a second set of files to be restored from the first set of files, the second set of files including the at least one file.

3. The method of claim 1 wherein the information related to the contents of the files in the plurality of files comprises:
for each file in the plurality of files:
information identifying one or more words in the file; and
for each word, a first value indicating the number of occurrences of the word in the file.

4. The method of claim 1 wherein the information related to the contents of the files in the plurality of files comprises:
for each file in the plurality of files:
information identifying one or more words in the file; and
for each word:
a first value indicating the number of occurrences of the word in the file; and
a second value indicating the number of occurrences of the word in title information associated with the file.

5. The method of claim 1 wherein the location information for the plurality of files comprises:
for each file in the plurality of files:
information identifying a storage device from the plurality of storage device on which the file is stored; and
information identifying a pathname for accessing the file from the storage device on which the file is stored.

6. The method of claim 1 wherein:
the first content comprises one or more words; and
the first set of one or more files comprises files that include the one or more words.

7. The method of claim 1 wherein the at least one file is a backup file.

8. The method of claim 1 wherein the at least one file is an archived file.

9. The method of claim 1 wherein:
the first storage device is at least one of an off-line storage device and a near-line device; and
restoring the at least one file from the first storage device comprises:
outputting information indicating that the at least one file is stored on the first storage device.

10. In a storage environment comprising a plurality of storage devices storing a plurality of files, the plurality of files comprising at least one of a backup file and an archived file, a method of restoring one or more files from the plurality of files, the method comprising:
storing attributes information identifying one or more attributes for files in the plurality of files;
storing location information identifying storage locations for files in the plurality of files;
receiving a request comprising information identifying a first attribute;
determining, based upon the attributes information, a first set of one or more files from the plurality of files that satisfy the first attribute;
determining, based upon the location information, storage location information for at least one file in the first set of files, the storage location information comprising information identifying a first storage device from the plurality of storage devices on which the at least one file is stored; and
restoring the at least one file from the first storage device.

11. The method of claim 10 further comprising:
outputting information identifying files in the first set of files; and
receiving a signal indicating selection of a second set of files to be restored from the first set of files, the second set of files including the at least one file.

12. The method of claim 10 wherein the attributes information comprises:
for each file in the plurality of files:
information identifying a time when the file was created; and
information identifying a time when the file was last modified.

13. The method of claim 10 wherein the location information for the plurality of files comprises:
for each file in the plurality of files:
information identifying a storage device from the plurality of storage device on which the file is stored; and
information identifying a pathname for accessing the file from the storage device on which the file is stored.

14. The method of claim 10 wherein the first attribute is selectable from a group of attributes comprising time of file creation, time when a file was last modified, time when a file was last accessed, authorship information for the file, and ownership information for the file.

15. The method of claim 10 wherein the at least one file is a backup file.

16. The method of claim 10 wherein the at least one file is an archived file.

17. The method of claim 10 wherein:
the first storage device is at least one of an off-line storage device and a near-line storage device; and
restoring the at least one file from the first storage device comprises:
outputting information indicating that the at least one file is stored on the first storage device.

18. In a storage environment comprising a plurality of storage devices storing a plurality of files, the plurality of files comprising at least one of a backup file and an archived file, a method of restoring one or more files from the plurality of files, the method comprising:
storing information related to contents of files in the plurality of files;
storing attributes information identifying one or more attributes for files in the plurality of files;
storing location information identifying storage locations for files in the plurality of files;
receiving a request comprising information identifying a first criterion;
determining, based upon the attributes information and the information related to the contents of the files in the plurality of files, a first set of one or more files from the plurality of files that satisfy the first criterion;
determining, based upon the location information, storage location information for at least one file in the first set of files, the storage location information comprising information identifying a first storage device from the plurality of storage devices on which the at least one file is stored; and
restoring the at least one file from the first storage device.

19. The method of claim 18 wherein the first criterion comprises information identifying a first content.

20. The method of claim 18 wherein the first criterion comprises information identifying a first attribute.

21. The method of claim 18 wherein the at least one file is a backup file.

22. The method of claim 18 wherein the at least one file is an archived file.

23. The method of claim 18 wherein the first storage device is at least one of an off-line storage device and a near-line storage device.

24. In a storage environment comprising a plurality of storage devices storing a plurality of files, the plurality of files comprising at least one of a backup file and an archived file, a data processing system for restoring one or more files from the plurality of files, the data processing system comprising:
a processor; and
a memory coupled to the processor,
wherein the memory is configured to store a plurality of code modules for execution by the processor, the plurality of code modules comprising:
a code module for receiving a request comprising information identifying a first content;
a code module for accessing information related to contents of files in the plurality of files;
a code module for determining, based upon the information related to the contents of the plurality of files, a first set of one or more files from the plurality of files that comprise the first content;
a code module for accessing location information identifying storage locations for files in the plurality of files;
a code module for determining, based upon the location information, storage location information for at least one file in the first set of files, the storage location information comprising information identifying a first storage device from the plurality of storage devices on which the at least one file is stored; and
a code module for restoring the at least one file from the first storage device.

25. The system of claim 24 wherein the plurality of code modules further comprises:
a code module for outputting information identifying files in the first set of files; and
a code module for receiving a signal indicating selection of a second set of files to be restored from the first set of files, the second set of files including the at least one file.

26. The system of claim 24 wherein the information related to the contents of the files in the plurality of files comprises:
for each file in the plurality of files:
information identifying one or more words in the file; and
for each word, a first value indicating the number of occurrences of the word in the file.

27. The system of claim 24 wherein the information related to the contents of the files in the plurality of files comprises:
for each file in the plurality of files:
information identifying one or more words in the file; and
for each word:
a first value indicating the number of occurrences of the word in the file; and
a second value indicating the number of occurrences of the word in title information associated with the file.

28. The system of claim 24 wherein the location information for the plurality of files comprises:
for each file in the plurality of files:
information identifying a storage device from the plurality of storage device on which the file is stored; and
information identifying a pathname for accessing the file from the storage device on which the file is stored.

29. The system of claim 24 wherein:
the first content comprises one or more words; and
the first set of one or more files comprises files that include the one or more words.

30. The system of claim 24 wherein the at least one file is a backup file.

31. The system of claim 24 wherein the at least one file is an archived file.

32. The system of claim 24 wherein:
the first storage device is at least one of an off-line storage device and a near-line storage device; and
the code module for restoring the at least one file from the first storage device comprises:
a code module for outputting information indicating that the at least one file is stored on the first storage device.

33. In a storage environment comprising a plurality of storage devices storing a plurality of files, the plurality of files comprising at least one of a backup file and an archived file, a data processing system for restoring one or more files from the plurality of files, the data processing system comprising:
a processor; and
a memory coupled to the processor,
wherein the memory is configured to store a plurality of code modules for execution by the processor, the plurality of code modules comprising:
a code module for accessing attributes information identifying one or more attributes for files in the plurality of files;
a code module for receiving a request comprising information identifying a first attribute;
a code module for determining, based upon the attributes information, a first set of one or more files from the plurality of files that satisfy the first attribute;
a code module for accessing location information identifying storage locations for files in the plurality of files;
a code module for determining, based upon the location information, storage location information for at least one file in the first set of files, the storage location information comprising information identifying a first storage device from the plurality of storage devices on which the at least one file is stored; and
a code module for restoring the at least one file from the first storage device.

34. The system of claim 33 wherein the plurality of code modules further comprises:
a code module for outputting information identifying files in the first set of files; and
a code module for receiving a signal indicating selection of a second set of files to be restored from the first set of files, the second set of files including the at least one file.

35. The system of claim 33 wherein the attributes information comprises:
for each file in the plurality of files:
information identifying a time when the file was created; and
information identifying a time when the file was last modified.

36. The system of claim 33 wherein the location information for the plurality of files comprises:
for each file in the plurality of files:
information identifying a storage device from the plurality of storage device on which the file is stored; and
information identifying a pathname for accessing the file from the storage device on which the file is stored.

37. The system of claim 33 wherein the first attribute is selectable from a group of attributes comprising time of file creation, time when a file was last modified, time when a file was last accessed, authorship information for the file, and ownership information for the file.

38. The system of claim 33 wherein the at least one file is a backup file.

39. The system of claim 33 wherein the at least one file is an archived file.

40. The system of claim 33 wherein:
the first storage device is at least one of an off-line storage device and a near-line storage device; and
the code module for restoring the at least one file from the first storage device comprises:
a code module for outputting information indicating that the at least one file is stored on the first storage device.

41. In a storage environment comprising a plurality of storage devices storing a plurality of files, the plurality of files comprising at least one of a backup file and an archived file, a data processing system for restoring one or more files from the plurality of files, the data processing system comprising:
a processor; and
a memory coupled to the processor,
wherein the memory is configured to store a plurality of code modules for execution by the processor, the plurality of code modules comprising:
a code module for receiving a request comprising information identifying a first criterion;
a code module for accessing information related to contents of files in the plurality of files and attributes information identifying one or more attributes for files in the plurality of files
a code module for determining, based upon the attributes information and the information related to the contents of the files in the plurality of files, a first set of one or more files from the plurality of files that satisfy the first criterion;
a code module for accessing location information identifying storage locations for files in the plurality of files;
a code module for determining, based upon the location information, storage location information for at least one file in the first set of files, the storage location information comprising information identifying a first storage device from the plurality of storage devices on which the at least one file is stored; and
a code module for restoring the at least one file from the first storage device.

42. The system of claim 41 wherein the first criterion comprises information identifying a first content.

43. The system of claim 41 wherein the first criterion comprises information identifying a first attribute.

44. The system of claim 41 wherein the at least one file is a backup file.

45. The system of claim 41 wherein the at least one file is an archived file.

46. The system of claim 41 wherein the first storage device is at least one of an off-line storage device and a near-line storage device.

47. A computer program product stored on a computer-readable storage medium for restoring one or more files from a plurality of files stored on a plurality of storage devices in a distributed storage environment, the plurality of files comprising at least one of a backup file and an archived file, the computer program product comprising:
code for receiving a request comprising information identifying a first content;
code for accessing information related to contents of files in the plurality of files;
code for determining, based upon the information related to the contents of the plurality of files, a first set of one or more files from the plurality of files that comprise the first content;
code for accessing location information identifying storage locations for files in the plurality of files;
code for determining, based upon the location information, storage location information for at least one file in the first set of files, the storage location information comprising information identifying a first storage device from the plurality of storage devices on which the at least one file is stored; and
code for restoring the at least one file from the first storage device.

48. The computer program product of claim 47 further comprising:
code for outputting information identifying files in the first set of files; and
code for receiving a signal indicating selection of a second set of files to be restored from the first set of files, the second set of files including the at least one file.

49. The computer program product of claim 47 wherein:
the information related to the contents of the files in the plurality of files comprises:
for each file in the plurality of files:
information identifying one or more words in the file; and
for each word:
a first value indicating the number of occurrences of the word in the file; and
a second value indicating the number of occurrences of the word in title information associated with the file; and
the location information for the plurality of files comprises:
for each file in the plurality of files:
information identifying a storage device from the plurality of storage device on which the file is stored; and
information identifying a pathname for accessing the file from the storage device on which the file is stored.

50. The computer program product of claim 47 wherein:
the first content comprises one or more words; and
the first set of one or more files comprises files that include the one or more words.

51. The computer program product of claim 47 wherein the at least one file is a backup file.

52. The computer program product of claim 47 wherein the at least one file is an archived file.

53. The computer program product of claim 47 wherein:
the first storage device is at least one of an off-line storage device and a near-line storage device; and
the code for restoring the at least one file from the first storage device comprises:
code for outputting information indicating that the at least one file is stored on the first storage device.

54. A computer program product stored on a computer-readable storage medium for restoring one or more files from a plurality of files stored on a plurality of storage devices in a distributed storage environment, the plurality of files comprising at least one of a backup file and an archived file, the computer program product comprising:
code for receiving a request comprising information identifying a first attribute;
code for accessing attributes information identifying one or more attributes for files in the plurality of files;
code for determining, based upon the attributes information, a first set of one or more files from the plurality of files that satisfy the first attribute;
code for accessing location information identifying storage locations for files in the plurality of files;
code for determining, based upon the location information, storage location information for at least one file in the first set of files, the storage location information comprising information identifying a first storage device from the plurality of storage devices on which the at least one file is stored; and
code for restoring the at least one file from the first storage device.

55. The computer program product of claim 54 further comprising:
code for outputting information identifying files in the first set of files; and
code for receiving a signal indicating selection of a second set of files to be restored from the first set of files, the second set of files including the at least one file.

56. The computer program product of claim 54 wherein:
the attributes information comprises:
for each file in the plurality of files:
information identifying a time when the file was created; and
information identifying a time when the file was last modified.
the location information for the plurality of files comprises:
for each file in the plurality of files:
information identifying a storage device from the plurality of storage device on which the file is stored; and
information identifying a pathname for accessing the file from the storage device on which the file is stored.

57. The computer program product of claim 54 wherein the first attribute is selectable from a group of attributes comprising time of file creation, time when a file was last modified, time when a file was last accessed, authorship information for the file, and ownership information for the file.

58. The computer program product of claim 54 wherein the at least one file is a backup file.

59. The computer program product of claim 54 wherein the at least one file is an archived file.

60. The computer program product of claim 54 wherein:
the first storage device is at least one of an off-line storage device and a near-line storage device; and
the code for restoring the at least one file from the first storage device comprises:
code for outputting information indicating that the at least one file is stored on the first storage device.

61. A computer program product stored on a computer-readable storage medium for restoring one or more files from a plurality of files stored on a plurality of storage devices in a distributed storage environment, the plurality of files comprising at least one of a backup file and an archived file, the computer program product comprising:
code for receiving a request comprising information identifying a first criterion;
code for accessing information related to contents of files in the plurality of files and attributes information identifying one or more attributes for files in the plurality of files;
code for determining, based upon the attributes information and the information related to the contents of the files in the plurality of files, a first set of one or more files from the plurality of files that satisfy the first criterion;
code for accessing location information identifying storage locations for files in the plurality of files;
code for determining, based upon the location information, storage location information for at least one file in the first set of files, the storage location information comprising information identifying a first storage device from the plurality of storage devices on which the at least one file is stored; and
code for restoring the at least one file from the first storage device.

62. The computer program product of claim 61 wherein the first criterion comprises information identifying a first content.

63. The computer program product of claim 61 wherein the first criterion comprises information identifying a first attribute.

64. The computer program product of claim 61 wherein the at least one file is a backup file.

65. The computer program product of claim 61 wherein the at least one file is an archived file.

66. The computer program product of claim 61 wherein the first storage device is at least one of an off-line storage device and a near-line storage device.
